(19) United States
(12) Patent Application Publication
(10) Pub. No.: US 2008/0245986 A1
(43) Pub. Date: Oct. 9, 2008

(54) Fluid Distribution and Regulation Valve and System for Supplying Gas Derived from Two Sources Comprising Same

(76) Inventors: Jean Arnault, Saint Nazaire Les Eymes (FR); Jean-Michel Cazenave, Seyssins (FR)

Correspondence Address: AIR LIQUIDE;Intellectual Property, 2700 POST OAK BOULEVARD, SUITE 1800, HOUSTON, TX, 77056, US

(21) Appl. No.: 11/576,875

(22) PCT Filed: Sep. 15, 2005
(86) PCT No.: PCT/FR05/50743

§ 371 Date: Jan. 23, 2008

(30) Foreign Application Priority Data
Oct. 7, 2004 (FR) 0452292

(51) Int. Cl. A62B 9/02; F16K 31/04

(52) U.S. Cl. 251/129.11; 128/207.16

(57) ABSTRACT

The invention concerns a valve wherein the valve spool (1) provides selective communications between inner zones (3 5) in the valve body (C) and is mobile between extreme left and right positions under the control of an electric servomotor whereof the spindle (10), connected to the valve spool through a connecting rod assembly (11, 14) whereof the connecting rod (11) is configured to have an abutting ridge (15) co-operating with the spindle (10) in an extreme position (13<SB>III</SB>) countering the action of the return spring (6) thus allowing a mono- and/or bistable operation of the valve. The invention is applicable to onboard systems for supplying breathing mixture to an aircraft occupant.

The present invention relates to fluid distribution and regulation valves of the type comprising a valve body defining at least three internal regions which can each be connected to an external fluid circuit, and a moving structure which can be moved between opposed first and second positions by an electric servo motor having a drive shaft and which is urged by an elastic element toward the first position.

A valve of this type is described in document EP-A-499505, in the name of the applicant.

In this type of valve, in the absence of any control or in the event of a loss of power supply, the moving structure is positioned and maintained in said first position by the elastic return element, thereby limiting the “rest” configurations of the fluid system incorporating such a valve.

The object of the present invention is to provide a strong and reliable valve of simple configuration that makes it possible to maintain the valve in an additional rest position and which can therefore be used as a valve having monostable and/or bistable operation that is especially suited to the distribution of fluids derived from two different sources.

To that end, according to a feature of the invention, the moving structure is connected to the drive shaft by a linkage which can be moved by the motor toward an extreme position where it cooperates in engagement with a stationary element opposing the action of the elastic element.

According to a more specific feature of the invention, the linkage comprises a link connected in an articulated manner to the moving structure and configured to cooperate in abutment with the stationary element, typically formed by the drive shaft, in said extreme position of the linkage.

Another object of the present invention is to provide a system for supplying gas derived from two sources to at least one user station, incorporating a valve as defined above whose said three internal regions are respectively connected to said gas sources and to the user station.

According to a specific feature of the invention, this gas supply system is an on-board system for supplying breathing gas to at least one breathing mask for an occupant of a vehicle, in particular an airborne vehicle, the gas sources containing oxygen or an oxygen-enriched mixture.

Other features and advantages of the invention will become apparent from the description of an embodiment given below by way of illustration but with no limitation being implied, with reference to the appended drawings, in which:

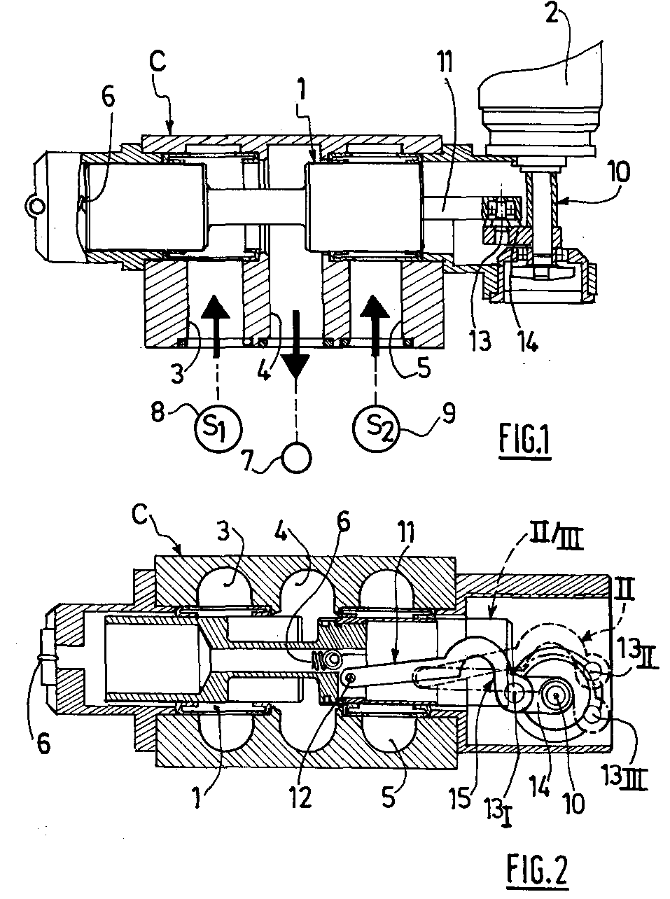

FIG. 1 is a schematic view in a horizontal longitudinal plane of section of an embodiment of a valve according to the invention; and

FIG. 2 is a view in vertical longitudinal section of the valve shown in FIG. 1.

In the embodiment represented in the figures, the general features of a fluid distribution and regulation valve according to the document EP-A-499505 mentioned above will be recognized, this valve essentially comprising a moving structure or valve slide 1 which can be moved, under the control of an electric servo motor 2, within aligned bearing surfaces of transverse partitions separating internal regions or chambers 3, 4 and 5 formed in a valve body C, two adjacent regions being hermetically separated from one another or communicating with one another depending on the position of the moving slide 1, as described in detail in the aforementioned document. The valve slide 1 is urged into the position toward the left in the drawings by a spring 6 extending into the slide between the right-hand portion thereof and the left-hand end of the body C.

According to one aspect of the invention, the distribution and regulation valve is arranged in a fluid supply and distribution system for supplying at least one user station 7 connected to the region 4 from at least two pressurized-fluid sources 8 and 9 respectively connected to the regions 3 and 5. More specifically, the user station 7 consists of at least one breathing mask for one of the crew members of a self-propelled vehicle, typically an aircraft, and the oxygen sources 8 and 9 respectively consist of pressurized oxygen bottles S₁ and of an on-board apparatus S₂ for separating oxygen from the air, commonly referred to as a concentrator or designated by the acronym OBOGS.

According to one aspect of the invention, the valve slide 1 is connected to the drive shaft 10 of the motor 2 by a linkage consisting, in the example represented, of a link 11 having one end connected in an articulated manner (axis 12) to the valve slide 1 and another end connected in an articulated manner (axis 13) to a crank pin 14 fixed to the drive shaft 10.

As can be seen more clearly from FIG. 2, the link 11 comprises, on its right-hand portion close to the axis 13, an arcuate region internally defining a bearing edge 15 which is substantially orthogonal to the sliding axis of the slide 1. The drive shaft 10 of the motor 2 is situated slightly below this longitudinal axis of the slide 1 such that, when the valve slide 1 is in the extreme position of movement toward the right II/III, as represented by a fine line in the figure, the axis 13 of articulation between the link 11 and the crank pin 14 is situated to the right of the vertical of the drive shaft 10, the travel of the valve slide 1 normally being modulated between the extreme-left position represented by a solid line in FIG. 2 and an extreme-right position with the axis 13 in the upper position 13, represented in FIG. 2, from where the valve slide can be permanently returned to the extreme-left position under the effect of the return spring 6, particularly in the event of a loss of power supply to the motor 2.

According to the invention, the extreme-right position of the valve slide 1 can also be obtained by actuating the drive shaft beyond the position 13_{II} of the axis 13 so as to bring it into a position 13_{III} below the shaft 10, with the butting edge 15 then bearing against said shaft. In this position, in the event of a loss of power supply, the return spring 6 is inoperative and the valve slide remains in the extreme-right position II/III, from which it can only be moved under the effect of a control (acting to the left in FIG. 2) from the motor 2.

To return to the normal operating configuration, it is merely required to actuate the drive shaft 10 to return the axis 13 into the position 13_{II} or toward the left, toward the extreme-left position 13_{I} with assistance from the return spring 6.

This arrangement is particularly useful in the case of an on-board system for supplying breathing air to at least one occupant of an aircraft where the source 8, connected to the left-hand region 3, consists of pressurized oxygen cylinders S₁ and where the source 9, connected to the right-hand region 5, consists of an on-board separator (OBOGS) S₂.

Thus, with the aircraft on the ground, the valve structure is positioned in the extreme-right configuration 13_{III}, a loss of power supply not preventing the valve structure from being maintained in the extreme-right position, closing the region 3 and, therefore, the cylinders S₁. By contrast, in flight, the valve structure typically operates between the positions 13, and 13, such that, in the event of a loss of power supply, in which case the OBOGS becomes inoperative, the valve passes safely into the extreme-left position, maintaining communication between the cylinders 8 and the masks 7 and isolating the OBOGS.

Although the present invention has been described in relation to a specific embodiment, it is not limited thereby but is open to modifications and variants which will become apparent to a person skilled in the art within the context of the claims which follow. In particular, the valve can be adapted to configurations in which the valve is a simple one-way valve with two positions, where one of the two inlets is closed, or to configurations in which the valve is a four-way/two-position valve. Furthermore, when the valve is supplied with electrical power, its extreme-left position can allow regulation of fluid flow or pressure between the source 8 and the user station 7.

1-6. (canceled)

7. A fluid distribution and regulation valve comprising a valve body defining at least three internal regions which can each be connected to an external fluid circuit, and a moving structure which can be moved between opposed first and second positions by an electric servo motor having a drive shaft and which is urged by an elastic element toward the first position, wherein the moving structure is connected to the drive shaft by a linkage which can be moved by the drive motor toward an extreme position where it cooperates in engagement with a stationary element opposing the action of the elastic element.

8. The valve of claim 7, wherein the linkage comprises a link connected in an articulated manner to the moving structure and configured to cooperate in abutment with the stationary element in said extreme position.

9. The valve of claim 8, wherein the link is connected in an articulated manner to a crank pin fixed to the drive shaft, the stationary element being formed by said drive shaft.

10. A system for supplying gas derived from two sources to at least one user station, comprising a valve of one claim 7 whose said three internal regions are respectively connected to said sources and to said user station.

11. The on-board system for supplying breathing gas of claim 10, in which the user station is a breathing mask, the gas sources containing oxygen.

12. The on-board system of claim 11, wherein one of the sources consists of an apparatus for separating oxygen from the air.
